(19) United States
(12) Patent Application Publication
(10) Pub. No.: US 2015/0161722 A1
(43) Pub. Date: Jun. 11, 2015

(54) DYNAMIC LOOK-UP TABLE FOR CHANGE ORDER LIMITS ON CUSTOMER ACCOUNTS

(71) Applicant: Bank of America Corporation, Charlotte, NC (US)

(72) Inventor: Thomas A. Harp, Mason, OH (US)

(73) Assignee: Bank of America Corporation, Charlotte, NC (US)

(21) Appl. No.: 14/097,502

(22) Filed: Dec. 5, 2013

(51) Int. Cl. G06Q 40/02; G06F 17/30

(52) U.S. Cl. CPC G06Q 40/02; G06F 17/30368; G06F 17/30477

(57) ABSTRACT

A dynamic look-up table for change order limits on customer accounts, which may be actualized as a database, is provided. The database may include a first set of data relating to a client's current change order limits. The database may include a second set of data relating to the client's historical change order limit variance, said historical change order limit variance comprising information relating to a plurality of historical change order limit adjustments over a pre-determined period of time. The database may include a third set of data relating to the client's requested change order limit. The database may be further configured to: flag the change order request as a grantable change order request if the requested change order limit is within a threshold value of an average historical change order limit adjustment, said average historical change order limit adjustment being based on the plurality of historical change order limit adjustments; and flag the requested change order request as a non-grantable change order request, when the requested change order limit is not within the threshold value of the average historical change order adjustment

### FIELD OF TECHNOLOGY

This invention relates to a tool for use in tracking users change order requests.

### BACKGROUND OF THE DISCLOSURE

A change order is a way for a customer of a financial institution to order currency. The change order may be requested by voice, through a telephone call, in person, by a facsimile transmission or by some other form of communication electronic or otherwise.

Typically, a customer who requests a change order enters client identification codes and requisite passwords for processing a change order. The financial institution typically receives the information and, if the client identification codes and passwords are correct, processes the change order and sends the currency through a secure method such as by client specified armored truck delivery.

In some circumstances, a financial institution may provide an automated change order system such as a phone system for automated change order requests. In such a system, a customer may dial into the automated change order system, enter a client ID number, enter password(s) and, if the information is accepted, enter the specific amount of the order and enter the time and day of requested delivery.

In order to enter a more specific order, the customer is required to specify the order to the denominational level. A telephone system as described above allows the customer to enter the denomination requested and the dollar amount of the denomination. The customer may be prompted to continue from denomination to denomination until the order is completely specified.

Because of the importance to a business of such change orders, such phone systems typically also provide information lines which allow a customer to inquire about the status of a recent change order. Such an information line may allow a customer to dial in to the system, enter the customer ID and password(s) and then further navigate the system to determine the status of the change order. Such navigation may return a message similar to the following message: “Your order for $XXXX was received on (month, day, year). Your order has (not) been processed. The dispatch date for your order is (month, day, year) and should reach you on (month, day, year).”

Typically, a financial institution associates each customer with a change order request limit. A change order request limit may correspond to the maximum amount of currency that the financial institution is prepared to disburse to each customer at one time. A change order request limit may typically limit exposure of the financial institution to the customer with whom the change order request limit is associated.

Business, however, is not static. Accordingly, customers' needs for currency change from time to time. While a financial institution may wish to limit the exposure to certain customers for any number of reasons, in order to support each customer's needs, the financial institution may be required, for certain high volume periods, to increase the limits on change orders. The increase may be temporary.

For example, a clothing retailer may have an increased need for currency at certain times of year—e.g., the end of November—during which their volume is high, but a lower need for currency at other times of the year.

It would be desirable for a financial institution to be able to use a relational database, which may include a dynamic look-up table, to react to customer's requests for adjustments to change order limits in a way that corresponds to historical reaction to requests for adjustments to change order limits.

It would also be desirable for a financial institution to use a relational database, which may include a dynamic look-up table, to be able to react to customer's requests for adjustments to change order limits whereby the financial institution's reaction specifies a length of time that corresponds to the length of time of a financial institution's historical reactions.

It would also be desirable for a financial institution to use a relational database, which may include a dynamic look-up table, to be able to project a customer's future requests for adjustments to change order limits.

### SUMMARY OF THE DISCLOSURE

A database according to the invention may include a first set of data relating to a client's current change order limits and a second set of data relating to the client's historical change order limit variance. The historical change order limit variance may include information relating to a plurality of historical change order limit adjustments over a pre-determined period of time. The database may further include a third set of data relating to the client's requested change order limit. The database may be configured to provide an index score that corresponds to: an indication to grant the change order request when the requested change order limit is within the threshold amount of time of a historical change order limit adjustment date, said historical change order limit adjustment date being a calendar date from a previous year in which a requested change order limit was granted; and an indication to deny the change order request when the requested change order limit is not within the threshold amount of time of a historical change order limit adjustment date.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows apparatus that may be used in accordance with the systems and methods of the invention;

FIG. 2A shows an illustrative change order request form which may be used with systems and methods according to the invention;

FIG. 2B shows an illustrative schematic diagram of a GUI which embodies systems and methods according to the invention;

FIG. 3 shows another illustrative schematic diagram of a GUI which embodies systems and methods according to the invention;

FIG. 4 shows an illustrative schematic diagram of another GUI which embodies systems and methods according to the invention;

FIG. 5 shows an illustrative diagram of historic change order information;

FIG. 6 shows an illustrative flow diagram of a process according to certain embodiments; and

FIG. 7 shows an illustrative flow diagram of a process according to certain embodiments.

### DETAILED DESCRIPTION OF THE DISCLOSURE

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

As will be appreciated by one of skill in the art upon reading the following disclosure, a dynamic look-up table for change order limits on customer accounts may be embodied as a method, a data processing system, or a computer program product. Accordingly, a dynamic look-up table for change order limits on customer accounts may take the form of an entirely hardware embodiment, an entirely software embodiment or an embodiment combining software and hardware aspects.

Furthermore, a dynamic look-up table for change order limits on customer accounts may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

In an exemplary embodiment, in the event that a dynamic look-up table for change order limits on customer accounts is embodied at least partially in hardware, the dynamic look-up table for change order limits on customer accounts may include one or more databases, receivers, transmitters, processors, modules including hardware and/or any other suitable hardware. Furthermore, the operations executed by the dynamic look-up table for change order limits on customer accounts may be performed by the one or more databases, receivers, transmitters, processors and/or modules including hardware.

For some embodiments, data for the dynamic look-up table for use in a relational database for change order limits on customer accounts may be retrieved from a number of distinct computer files, such as tables.

Relational databases use tables to store information. The standard fields and records are represented as columns (fields) and rows (records) in a table. Typically, the table includes a header with a name that identifies the table.

With a relational database, the arrangement of data in columns allows for a faster comparison of information than with legacy databases. A relational database can use the relationship of similar data to increase the speed and versatility of the database.

The “relational” part of the name comes into play because of mathematical relations. A typical relational database has anywhere from 10 to more than 1,000 tables. Each table contains a column or columns that other tables can key on to gather information from that table.

By storing this information in another table, the database can create a single small table with the locations that can then be used for a variety of purposes by other tables in the database. A typical large database, may contain hundreds or thousands of tables; all which can be used together to quickly find the exact information needed at any given time.

Relational databases are created using a special computer language, e.g., structured query language (SQL), that is the standard for database interoperability.

Certain embodiments may include a non-transitory computer readable medium that stores a relational database. The database may include a first set of data, set forth as a column in a table, relating to a client's current change order limits.

The database may also include a second set of data, which may be stored in the same table or in a different table, relating to the client's historical change order limit variance. The historical change order limit variance may include information relating to a plurality of historical change order limit adjustments over a pre-determined period of time.

The database may also include a third set of data, which may be stored in same table as the first set of data, the same table as the second set of data or in its own table, relating to the client's requested change order limit.

The database may be further configured to respond to a query. The query may be as follows. If a requested change order limit is either less than or equal to the present change order limit or, in the alternative, is within a threshold value of an average historical change order limit adjustment then the database may be configured to flag the change order request as one that can be granted and report the flagged information to the requester.

The average historical change order limit adjustment may be based on the plurality of historical change order limit adjustments. The grant may occur preferably absent other countervailing factors. If the requested change order limit is not within the threshold value of the average historical change order adjustment, may be configured to flag the requested change order limit as one that, based on historical information, may not be immediately grantable, pending additional review.

If the requested change order limit is not within a threshold amount of time of a historical change order limit adjustment date, then the database may be configured to flag the change order request as one that is not immediately grantable.

In certain embodiments, the database may be configured to provide other information in response to a request for a change order limit adjustment. For example, the database may be configured to reply with an index score associated with the requested change order limit adjustment. The index score may be based on factors associated with the customer's historical change order limits. The index score may be based on factors associated with the customer's historical payment performance. The index score may be based on factors associated with the customer's credit. The factors may be based on the timing—e.g., the start date and the end date—of the customer's historical change order limit adjustment requests.

In certain embodiments, the historical change order limit adjustment date may be a calendar date from a previous year in which a requested change order limit was granted.

In certain embodiments, the database may be configured to receive a start time input for the granted change order limit.

In certain embodiments, the database may be configured to receive an end time input for the granted change order limit.

In certain embodiments, the database may be configured to determine a start time for the granted change order request limit and an end time for the granted change order request limit. The start time and/or the end time for the granted change order request limit may be based, at least in part, on historical change order limits.

In certain embodiments, the database may be configured to determine a start time for the granted change request limit and an end time for the granted change order request limit. The start time and/or the end time for the granted change order request limit may be based, at least in part, on granted historical change order limit requests.

In certain embodiments, the database may be configured to receive an input of a start time for a granted change order limit request and/or an end time for a granted change order limit request.

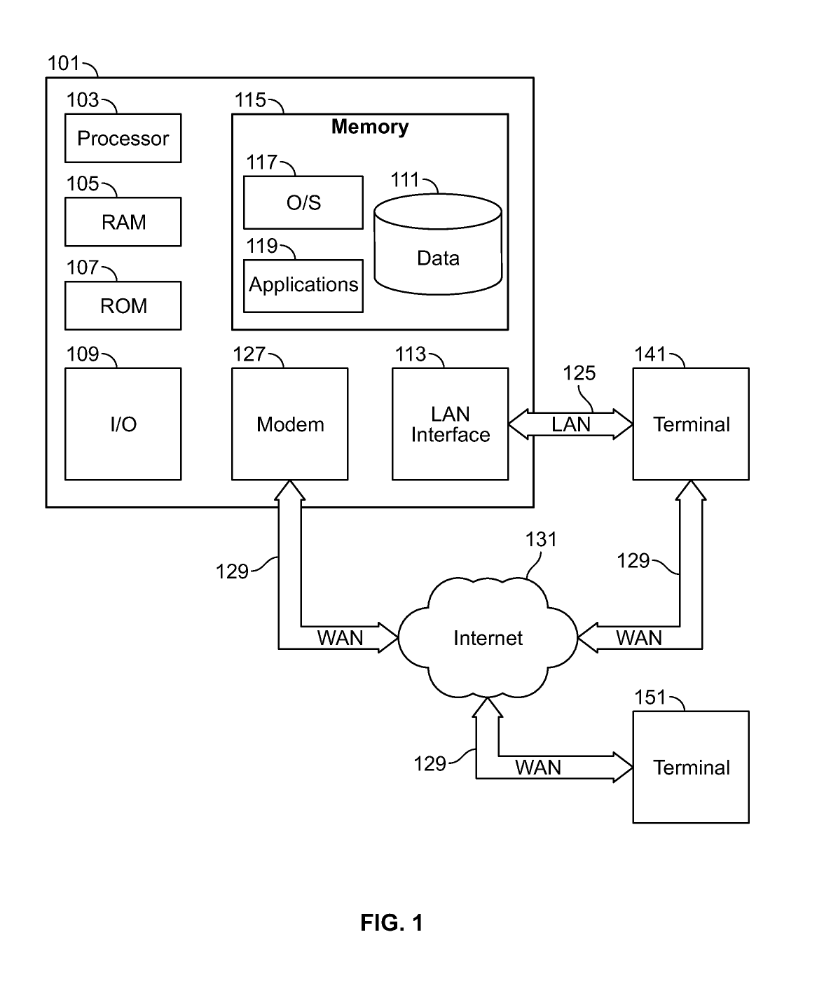

FIG. 1 is a block diagram that illustrates a generic computing device 101 (alternately referred to herein as a “server”) that may be used according to an illustrative embodiment of the invention. The computer server 101 may have a processor 103 for controlling overall operation of the server and its associated components, including RAM 105, ROM 107, input/output module (“I/O”) 109, and memory 115.

I/O module 109 may include a microphone, keypad, touch screen, and/or stylus through which a user of server 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 111. Alternately, some or all of server 101 computer executable instructions may be embodied in hardware or firmware (not shown). As described in detail below, database 111 may provide storage for information input into to implement a dynamic look-up table, which may form part of a relational database, for change order limits on customer accounts.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (“LAN”) 125 and a wide area network (WAN) 129, but may also include other networks. When used in a LAN networking environment, computer 101 is connected to LAN 125 through a network interface or adapter 113. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages via the World Wide Web from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

A terminal such as 141 or 151 may be used by a user of a dynamic look-up table for change order limits on customer accounts to view, and/or review, the number of historical (and/or projected) change order request limits relating, the rate of change order requests on a week-to-week, month-to-month, year-to-year, or other suitable amount of time, basis. Information input for use with a dynamic look-up table for change order limits on customer accounts may be stored in memory 115. The input information may be processed by an application such as one of applications 119.

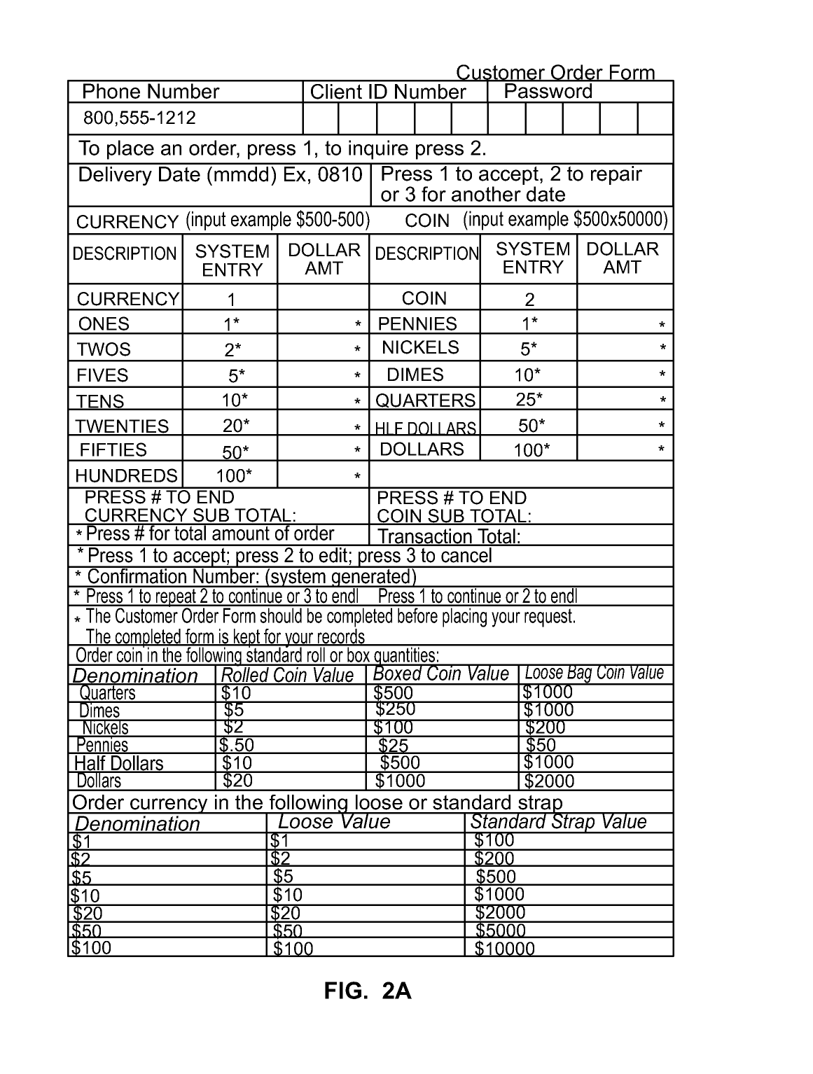

FIG. 2A shows a conventional change order request form which may be used with systems and methods according to the invention. Such a change order request may preferably include spaces to enter a client ID number, a password, a delivery date, currency input fields, coin input fields, a currency subtotal field, a coin sub-total field, a transaction total field, a confirmation number field (the contents of which may be system generated), standard coin roll or coin box specification fields and loose paper money and/or standard strap paper money specification fields.

FIG. 2B shows an illustrative schematic diagram of a GUI 200. FIG. 2B shows an exemplary financial institution client, Shopper's Haven at Druid Hills. The client preferably has a client ID.

GUI 200 shows informational request region 202 that includes information associated with a client ID. Region 202 may preferably include a request amount 204, a current customer request amount limit 204, a currency breakdown region 212, which, itself, may include an amount 208 for each currency of the currency breakdown.

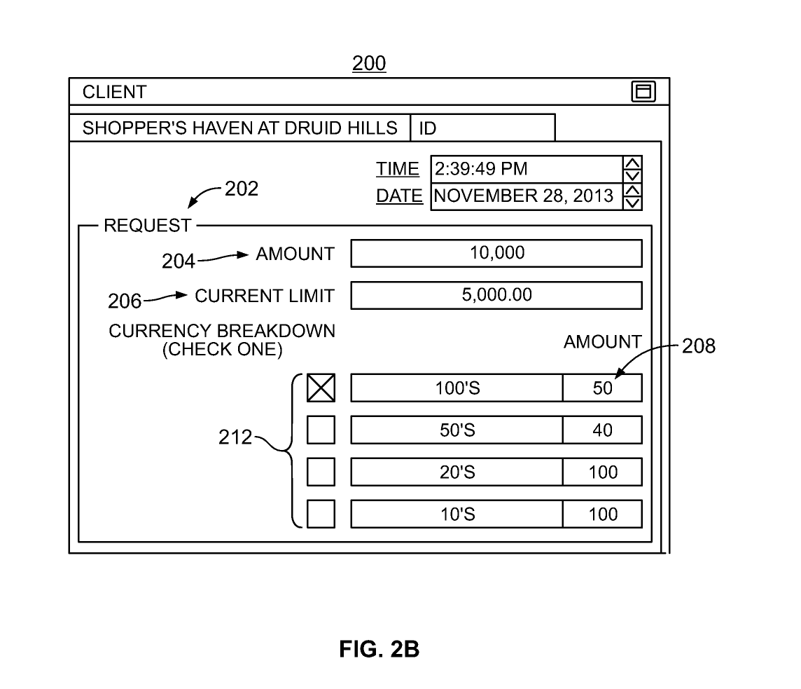

FIG. 3 shows an illustrative schematic diagram of a GUI 300 which embodies systems and methods according to the invention.

GUI 300 also shows informational request region 302 that includes information associated with the customer identified in the client ID. Similar to region 202, region 302 of GUI 300 may preferably include a request amount 304, a current customer request amount limit 306 and a currency breakdown region 312. The currency breakdown region 312 preferably includes an amount 308 for each currency of the currency breakdown.

GUI 300 may also include a requested change order limit adjustment region 313. Region 313 may include requested start date field 314. Requested start date field 314 may include a requested start date associated with the requested change order limit adjustment.

Region 313 may include requested end date field 316. Requested end date field 316 may include a requested end date associated with the requested change order limit adjustment.

Region 313 may include a current limit field 318. Region 313 may include a requested limit field 320.

It should be noted that GUI 300 shown may be resident on a customer's display for inputting information into the various fields. In the embodiment shown in FIG. 3, the change request is preferably input together with a requested change order limit adjustment.

It should be noted that GUI 300 shown may be resident on a financial institution's display for reviewing input information into the various fields.

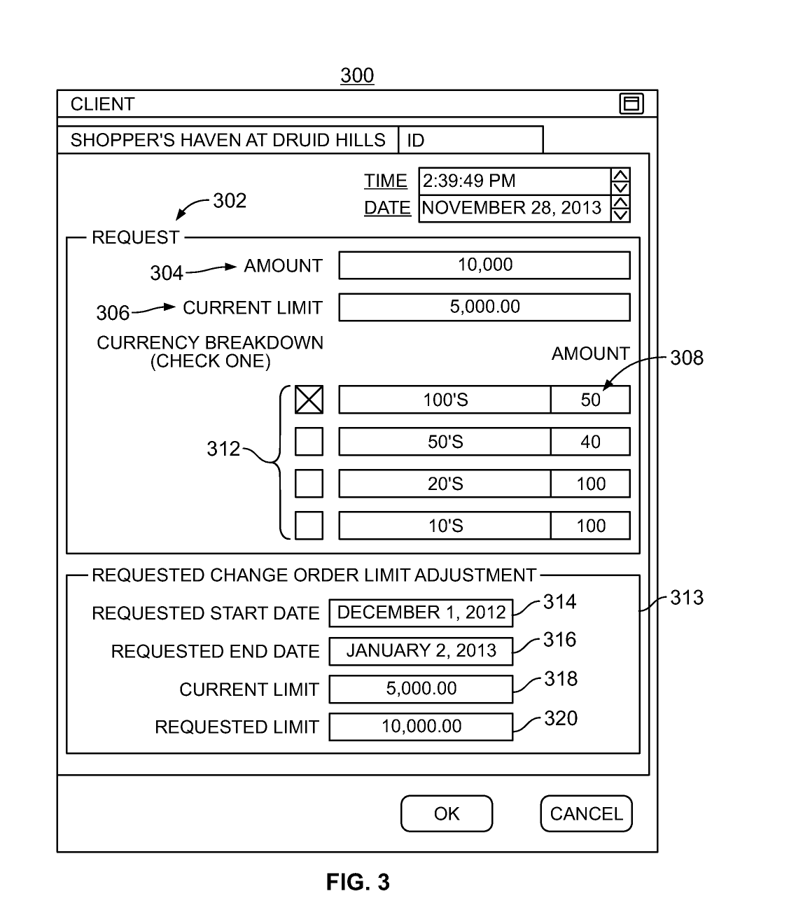

FIG. 4 shows an illustrative schematic diagram of another GUI which embodies systems and methods according to the invention. FIG. 4 shows substantially the same information as shown in region 302 of FIG. 3. FIG. 4 shows region 402 that includes requested start date field 404. Region 402 may include requested end date field 406. Region 402 may include a current limit field 408. Region 402 may include a requested limit field 410. It should be noted that the information input by a customer into region 402 may preferably be used as input formation for the various questions set forth in Table 1 below.

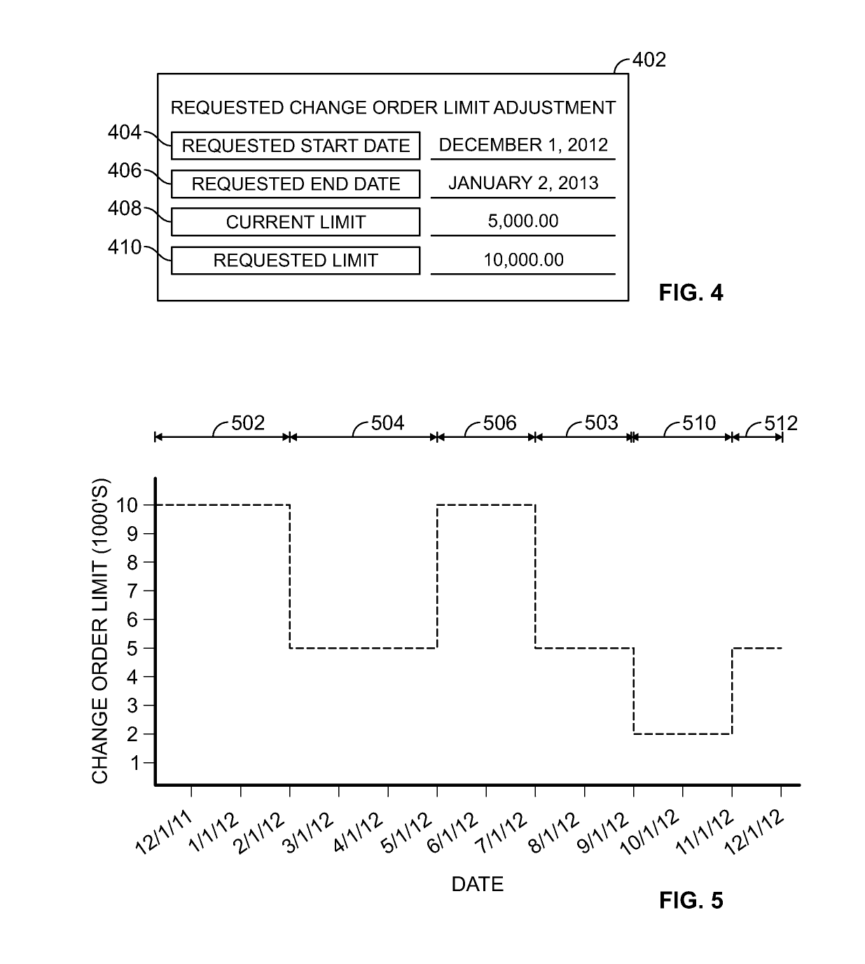

FIG. 5 shows an illustrative diagram of historic change order information. FIG. 5 shows an exemplary of one year of data. FIG. 5 shows the change order limit in thousands as charted against a 12-month window. In certain embodiments of the invention, the 12-month window may be a moving window—i.e., a window that is configured to shift with the passing of time.

A diagram such as the diagram shown in FIG. 5, and/or the content corresponding to the subject matter illustrated in the diagram shown in FIG. 5, may be used to authorize or deny requested change order limit adjustments. For example, the diagram in FIG. 5 shows a system that receives and stores a year's worth of information regarding change order request limits.

Region 502 shows that between Dec. 1, 2011 and Feb. 1, 2012, the change order request limit was set to 10K. Region 504 shows that between Feb. 1, 2012 and May 1, 2012, the change order request limit was set to 5K. Region 506 shows that between May 1, 2012 and Jul. 1, 2012, the change order request limit was set to 10K. Region 508 shows that between Jul. 1, 2012 and Sep. 1, 2012, the change order request limit was set to 5K. Region 510 shows that between Sep. 1, 2012 and Nov. 1, 2012, the change order request limit was set to 2.5K. Region 512 shows that from Nov. 1, 2012, the change order request limit was set to 5K.

In certain embodiments, the information received and stored by a system, and displayed in a diagram as shown in FIG. 5, may be used for analytics and determination of further action. For example, in certain embodiments, a customer may request an increase on the change order limit from 5K to 10 K during the heavy shopping months of November and December. A system may be configured to check data stored in a database regarding historical requests for adjustments to the change order limit. The system may determine whether the customer qualifies for a requested adjustment, preferably independent of manual intervention, based on the customer's historical requests for adjustments to the change order limit. In addition, the system may determine whether the customer qualifies for a requested adjustment, preferably independent of manual interview, based on the whether the customer's historical requests for adjustments to the change order limit have been granted.

In certain embodiments, the system may determine whether the customer qualifies for a requested adjustment, preferably independent of manual intervention, based on the timing of the customer's historical requests for adjustments. In certain embodiments, the system may determine whether the customer qualifies for a requested adjustment, preferably independent of manual intervention, based on the prior granting of the customer's historical request for adjustments. In some embodiments, certain requested adjustments may be granted without a second level review based, at least in part, on historical timing and/or success of previously requested adjustments.

Where a customer's request does not trigger a grant independent of manual intervention, such a request may be transmitted to appropriate departments for manual review.

Table 1 shows exemplary algorithms for determining whether a grant of change order limit adjustment may be triggered in response to a requested change order limit adjustment. It should be noted that one or more of the algorithms may be implemented concurrently in order to obtain a total index score. In certain embodiments of the invention, the output of each one of the algorithms may be weighted prior to using the output of the algorithm in determining the index score. Such a total index score may be compared with a threshold value to determine whether the requested change order limit adjustment may be granted independent of manual intervention.

TABLE 1
Exemplary Algorithm Inputs for Decision to Grant of Change Order
Limit Adjustment

| | Exemplary |
|---|---|
| Exemplary Algorithm Inputs | Weight (1-5) |
| Has a requested change order limit adjustment of the same | 5 |
| value ever been granted for the same customer? | |
| Has a requested change order limit adjustment ever been | 4 |
| granted for the same, or substantially the same, customer | |
| in the same time period? | |
| Are there any additional factors affecting a determination | 3 |
| of a grant for a requested change order limit adjustment of | |
| the customer? | |

Upon receipt of all the information regarding the customer's account, the system may preferably make a decision by weighting the outputs to the questions, compiling the weighted outputs to the questions, and comparing the single, compiled, index output score to a threshold index score.

In certain embodiments, when the index output score is greater than the threshold value, then the system may provide a grant for the requested change order limit adjustment. In certain embodiments, when the weighted output is lower than the threshold value, then the system may deny a grant for the requested change order limit adjustment, and transmit the requested change order limit adjustment for manual disposition.

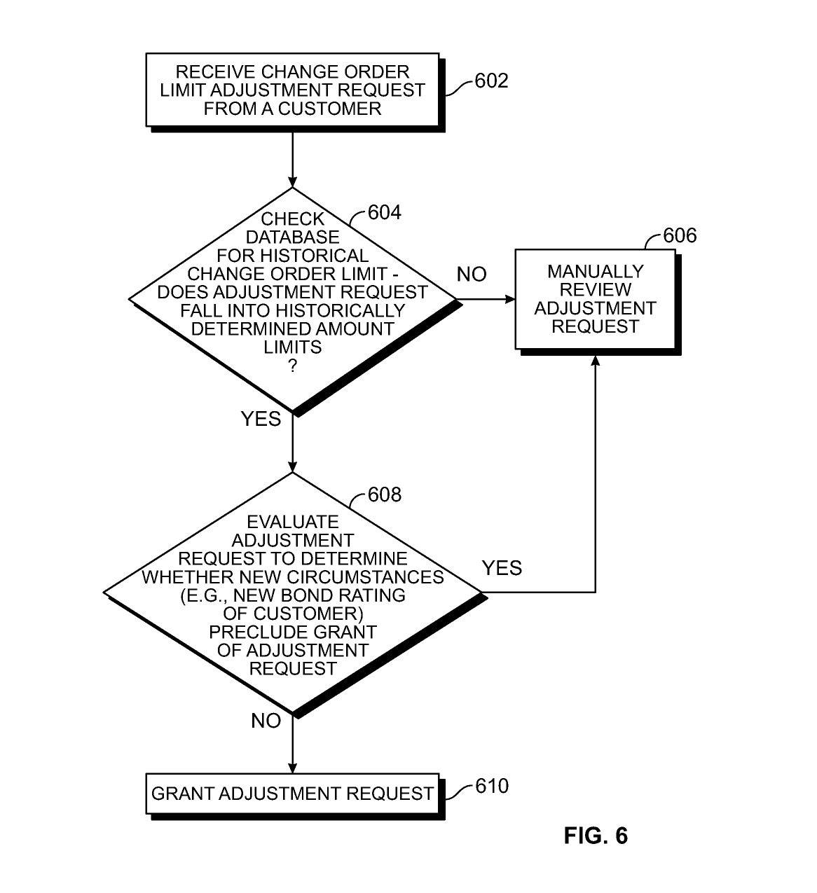

FIG. 6 shows an illustrative flow diagram of a process according to certain embodiments. Step 602 shows receiving a change order limit adjustment request from a customer. Step 604 shows querying a database for a historical change order limit.

Specifically, step 604 shows determining whether the adjustment request falls within historically permitted change order limits. If the adjustment request falls outside historically permitted limits, then step 606 shows sending the adjustment request for manual review.

If the adjustment request falls within historically permitted limits, then step 608 shows evaluating the adjustment request to determine whether new circumstances—e.g., a new bond rating for the customer, reported news about the customer, or other relevant information—precludes a grant of the adjustment request independent of manual intervention.

If step 608 determines that no relevant new circumstances exist, then step 610 shows granting the adjustment request. If relevant new circumstances exist, then step 606 shows sending the adjustment request for manual review.

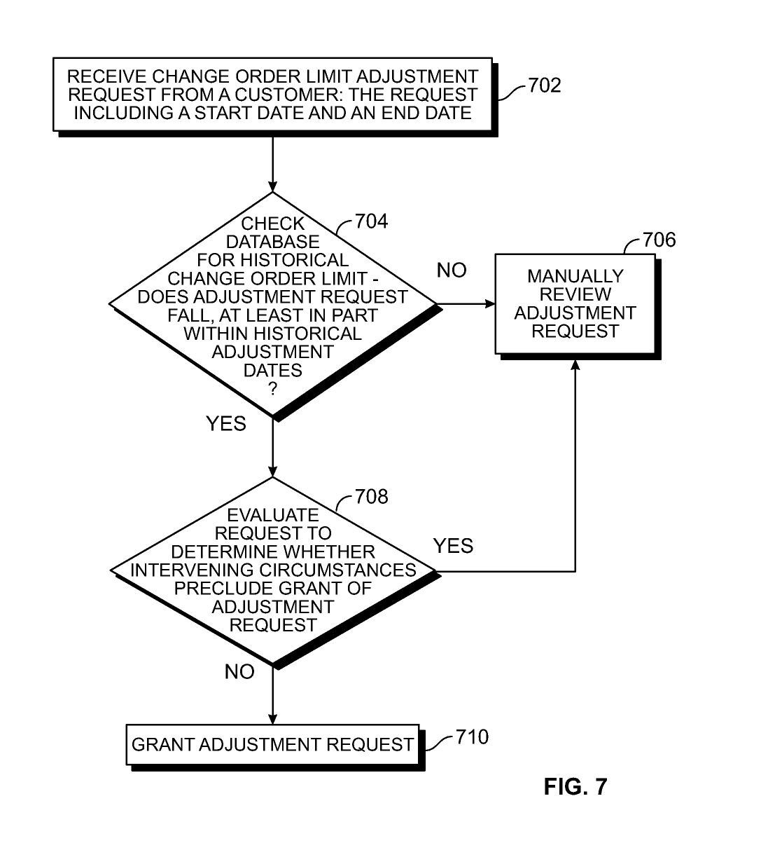

FIG. 7 shows an illustrative flow diagram of a process according to certain embodiments. Step 702 shows receiving a change order limit adjustment request from a customer. The request may include a start date and an end date. Step 704 shows querying whether a database for historical change order limit information includes information that corresponds to the requested start date and the requested end date such that the requested change order limit adjustment falls in a time period that coincides, at least in part, with a time period in which historical change order limit adjustments have been granted.

Step 706 shows that, when the requested adjustment request falls outside, or substantially outside, historically permitted time limits, then the system may send the adjustment request for manual review.

Step 708 shows evaluating the request to determine whether intervening circumstances preclude grant of an adjustment request. If one or more intervening circumstances precludes grant of an adjustment request, then the system may send the adjustment request for manual review. If intervening circumstances do not preclude grant of an adjustment request, then the system may grant the adjustment request as shown in step 710.

Thus, methods and apparatus for a dynamic look-up table for change order limits on customer accounts in accordance with the systems and methods of the invention have been provided. Persons skilled in the art will appreciate that the present invention can be practiced in embodiments other than the described embodiments, which are presented for purposes of illustration rather than of limitation, and that the present invention is limited only by the claims that follow.

What is claimed is:

1. A non-transitory computer readable medium comprising a database, the database comprising:
a first set of data relating to a client's current change order limits;
a second set of data relating to the client's historical change order limit variance, said historical change order limit variance comprising information relating to a plurality of historical change order limit adjustments over a pre-determined period of time; and
a third set of data relating to the client's requested change order limit;
wherein the database is configured to:
flag the change order request as a grantable change order request if the requested change order limit is within a threshold value of an average historical change order limit adjustment, said average historical change order limit adjustment being based on the plurality of historical change order limit adjustments; and
flag the requested change order request as a non-grantable change order request, when the requested change order limit is not within the threshold value of the average historical change order adjustment.

2. The computer readable medium of claim 1, wherein, when the requested change order limit is not within a threshold amount of time of a historical change order limit adjustment date, said historical change order limit adjustment date being a calendar date from a previous year in which a requested change order limit was granted, then the database is configured to deny the change order request.

3. The computer readable medium of claim 1, wherein the database is configured to receive a start time input for the granted change order limit.

4. The computer readable medium of claim 1, wherein the database is configured to receive an end time input for the granted change order limit.

5. The computer readable medium of claim 1, wherein the database is configured to determine a start time for a granted change request limit and an end time for the granted change order request limit based, at least in part on historical change order limits.

6. The computer readable medium of claim 1, wherein the database is configured to determine a start time for a granted change request limit and an end time for the granted change order request limit based, at least in part, on granted historical change order limit requests.

7. The computer readable medium of claim 1, wherein the database is configured to receive an input of a start time for a granted change order limit request and an end time for a granted change order limit request.

8. The computer readable medium of claim 1, wherein the first, second and third and sets of data can be displayed on a computerized graphical device in the form of a multi-dimensional tabular display or a graphical display that shows a correspondence between the data in the first, second and third sets of data and a determination to grant the request.

9. A non-transitory computer readable medium comprising a database, a computer readable medium comprising:
a first set of data relating to a client's current change order limits;
a second set of data relating to the client's historical change order limit variance, said historical change order limit variance comprising information relating to a plurality of historical change order limit adjustments over a pre-determined period of time; and
a third set of data relating to the client's requested change order limit;
wherein the database is configured to:
grant the change order request when the requested change order limit is within a threshold amount of time of a historical change order limit adjustment date, said historical change order limit adjustment date being a calendar date from a previous year in which a requested change order limit was granted; and
when the requested change order limit is not within a threshold amount of time of a historical change order limit adjustment date, said historical change order limit adjustment date being a calendar date from a previous year in which a requested change order limit was granted, the database is configured to deny the change order request.

10. The computer readable medium of claim 9, wherein, when the requested change order limit is not within the threshold value of an average historical change order adjustment, then the fourth set of data is configured to deny the requested change order limit.

11. The computer readable medium of claim 9, wherein the database is configured to receive a start time input for a granted change order limit.

12. The computer readable medium of claim 9, wherein the database is configured to receive an end time input for a granted change order limit.

13. The computer readable medium of claim 9, wherein the database is configured to determine a start time for a granted change request limit and an end time for the granted change order request limit based, at least in part, on historical change order limits.

14. The computer readable medium of claim 9, wherein the database is configured to determine a start time for a granted change request limit and an end time for the granted change order request limit based, at least in part, on granted historical change order limit requests.

15. The computer readable medium of claim 9, wherein the database is configured to provide information to populate a Graphical User Interface (“GUI”) with an input of a start time for a granted change order limit request and an end time for the granted change order limit request.

16. The computer readable medium of claim 9, wherein the first, second and third and sets of data can be displayed on a computerized graphical device in the form of a multi-dimensional tabular display or graphical display that shows a correspondence between the data in the first, second and third sets of data and the determination to grant the request.

17. A non-transitory computer readable medium comprising a database, the computer readable medium comprising:
a first set of data relating to a client's current change order limits;
a second set of data relating to the client's historical change order limit variance, said historical change order limit variance comprising information relating to a plurality of historical change order limit adjustments over a pre-determined period of time; and
a third set of data relating to the client's requested change order limit;
wherein the database is configured to:
provide an index score that corresponds to:
an indication to grant the change order request when the requested change order limit is within the threshold amount of time of a historical change order limit adjustment date, said historical change order limit adjustment date being a calendar date from a previous year in which a requested change order limit was granted; and
an indication to deny the change order request when the requested change order limit is not within the threshold amount of time of a historical change order limit adjustment date.

18. The computer readable medium of claim 17, wherein, when the requested change order limit is not within a threshold value of an average historical change order adjustment, then the database is configured to deny the requested change order limit.

19. The computer readable medium of claim 17, wherein the database is configured to receive a start time input for a granted change order limit.

20. The computer readable medium of claim 17, wherein the database is configured to receive an end time input for a granted change order limit.

21. The computer readable medium of claim 17, wherein the database is configured to determine a start time for a granted change request limit and an end time for the granted change order request limit based, at least in part, on historical change order limits.

22. The computer readable medium of claim 17, wherein the database is configured to determine a start time for a granted change request limit and an end time for the granted change order request limit based, at least in part, on granted historical change order limit requests.

23. The computer readable medium of claim 17, wherein the database is configured to provide information to populate a Graphical User Interface (“GUI”) with an input of a start time for a granted change order limit request and an end time for the granted change order limit request.

24. The computer readable medium of claim 17, wherein the first, second and third and sets of data can be displayed on a computerized graphical device in the form of a multi-dimensional tabular display or a graphical display which shows a correspondence between the data in the first, second and third sets of data and a determination to grant the request.
